(19) United States
(12) Patent Application Publication
(10) Pub. No.: US 2023/0367655 A1
(43) Pub. Date: Nov. 16, 2023

(54) METHOD AND APPARATUS FOR CONTROLLING SERVICING OF MULTIPLE QUEUES

(71) Applicant: Intel Corporation, Santa Clara, CA (US)

(72) Inventors: Yashaswini Raghuram PRATHIVADI BHAYANKARAM, Hillsboro, OR (US); Kevin C. SCOTT, Forest Grove, OR (US); Miles PENNER, Newberg, OR (US); Chinh T. CAO, Beaverton, OR (US); Deepthi KAVALUR, San Jose, CA (US)

(21) Appl. No.: 18/226,195

(22) Filed: Jul. 25, 2023

(51) Int. Cl. G06F 9/50

(52) U.S. Cl. CPC G06F 9/5083; G06F 9/5072

(57) ABSTRACT

A method is described. The method includes respectively adding respective identifiers of respective queues that provide packets to a CPU to a list in response to the respective queues being deemed quiet. The method includes, as a consequence of an interrupt having been generated in response to one of the respective queues having received a packet, removing the respective identifiers from the list and executing respective poll service handlers for the respective queues. The method includes disabling those of the respective poll service handlers and adding those of the respective identifiers back to the interrupt cause list for those of the respective queues that are again deemed quiet, while, continuing executing others of the respective poll service handlers for others of the respective queues that are not deemed quiet.

### BACKGROUND

As computing environments (such as data center environments) continue to rely on high speed, high bandwidth networks to interconnect their various computing components, system managers are increasingly focused on their systems' ability to process packets quickly, reliably, and at large scale.

### BRIEF DESCRIPTION OF THE FIGURES

FIG. 1 shows a plurality of CPUs and a network interface controller (NIC);

FIG. 2 shows the CPUs and NIC of FIG. 1 with a NIC device driver and NIC API.

FIGS. 3a through 3m depict a methodology for feeding receive packets to the CPUs from the NIC;

FIG. 4 pertains to feeding the NIC with packets from the CPUs;

FIG. 5 depicts a packet processing pipeline;

FIG. 6 depicts a data center environment;

FIG. 7a depicts an infrastructure processing unit (IPU);

FIG. 7b depicts a more detailed view of an infrastructure processing unit (IPU).

### DETAILED DESCRIPTION

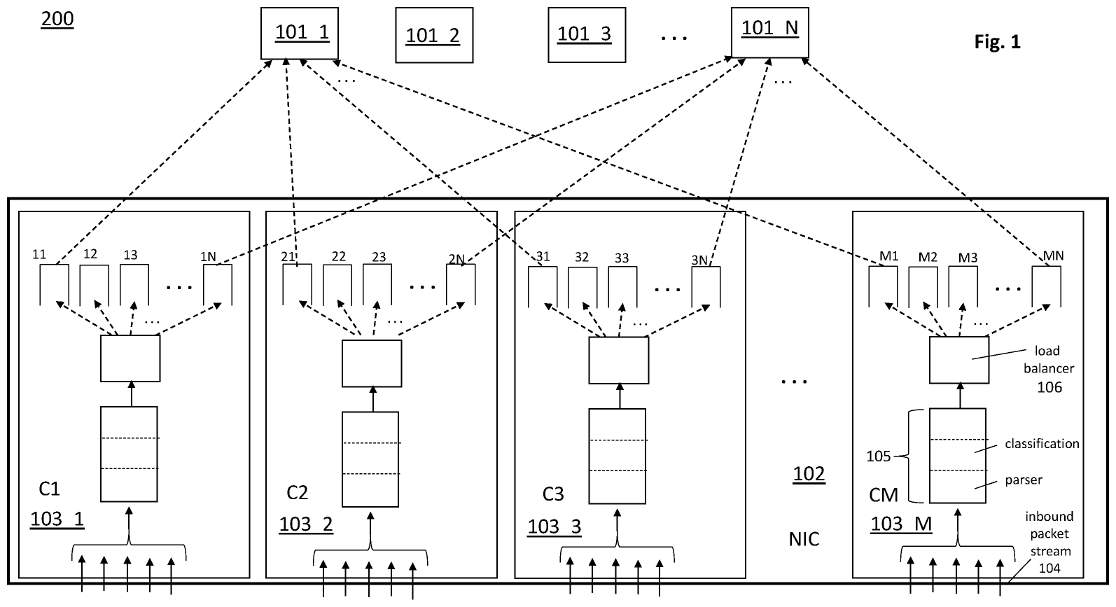

FIG. 1 shows an implementation where multiple CPUs 101_1, 101_2, 101_3 . . . 101_N are used to process packets that are received by the multiple receive channels 103_1, 103_2, 103_3 . . . 103_M of a network interface controller (NIC) 102. As observed in FIG. 1, each receive channel includes a packet processing pipeline 105 followed by a load balancer 106 (for illustrative ease only the packet pipeline 105 and load balancer 106 of receive channel 103_M is labeled with a reference number). Each receive channel's respective pipeline and load balancer feed N respective output queues. That is, the packet processing pipeline and load balancer of receive channel 103_1 feeds queues 11, 12, . . . 1N, the packet processing pipeline of receive channel 103_2 feeds queues 21, 22, . . . 2N, etc.

In the particular example of FIG. 1, the N output queues of each receive channel are uniquely assigned to feed a different one of the CPUs 101_1, 101_2, 101_3 . . . 101_N. For example: 1) queues 11, 21, 31 . . . M1 of receive channels 103_1, 103_2, 103_3 . . . 103_M feed CPU 101_1; 2) queues 12, 22, 32 . . . M2 of receive channels 103_1, 103_2, 103_3 . . . 103_M feed CPU 101_2; . . . ; and M) queues 1N, 2N, 3N . . . MN of receive channels 103_1, 103_2, 103_3 . . . 103_M feed CPU 101_N. For ease of understanding, FIG. 1 depicts the above described queue assignments for CPUs 101_1 and 101_N.

Here, the packet processing pipelines can perform, e.g., physical layer, data link layer and flow classification functions upon the inbound packet streams, while, the CPUs 101 perform multiprotocol label switching (MPLS) or other type of packet routing function on the inbound packet streams.

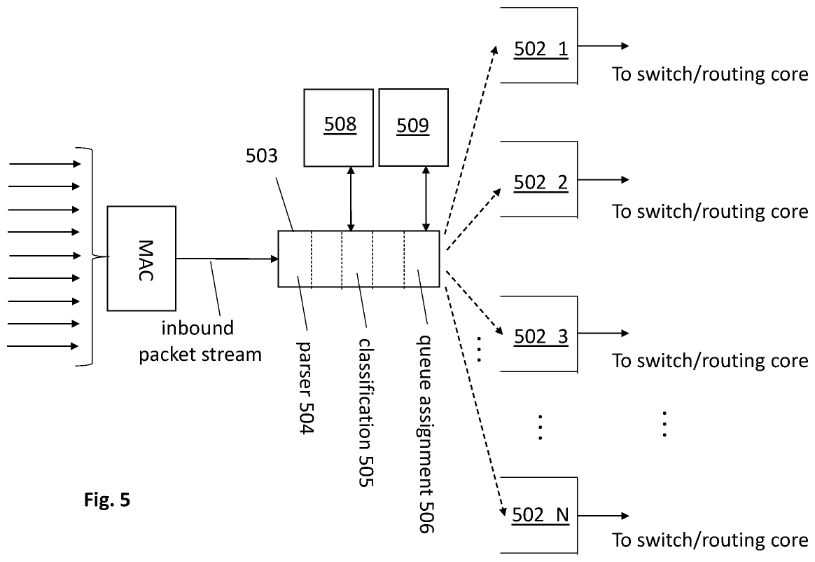

The load balancer of each receive channel 103_1 through 103_M is responsible for assigning a particular packet to a particular one of the channel's N output queues, which, in turn, effectively assigns the packet to the output queue's corresponding CPU for processing (e.g., if the packet processing pipeline of receive channel 103_1 assigns a packet to output queue 1N, the packet will be processed by CPU 101_N). In various embodiments, the load balancer of each receive channel includes receive side scaling (RSS) functionality that attempts to spread received packet flows evenly across the CPUs 101_1, 101_2, 101_3 . . . 101_N by (ideally) assigning packets evenly across the receive channel's N output queues. Other packet processing pipeline and/or load balancer implementations are possible and are described more fully below with respect to FIG. 5.

Notably the particular number of queues per packet processing pipeline, the particular mechanism by which a packet processing pipeline assigns packets to a particular one of its output queues and the particular arrangement of which CPUs are fed by which receive channel output queues is only exemplary and can vary from embodiment to embodiment. Some of these embodiments are discussed further below towards the end of this detailed description.

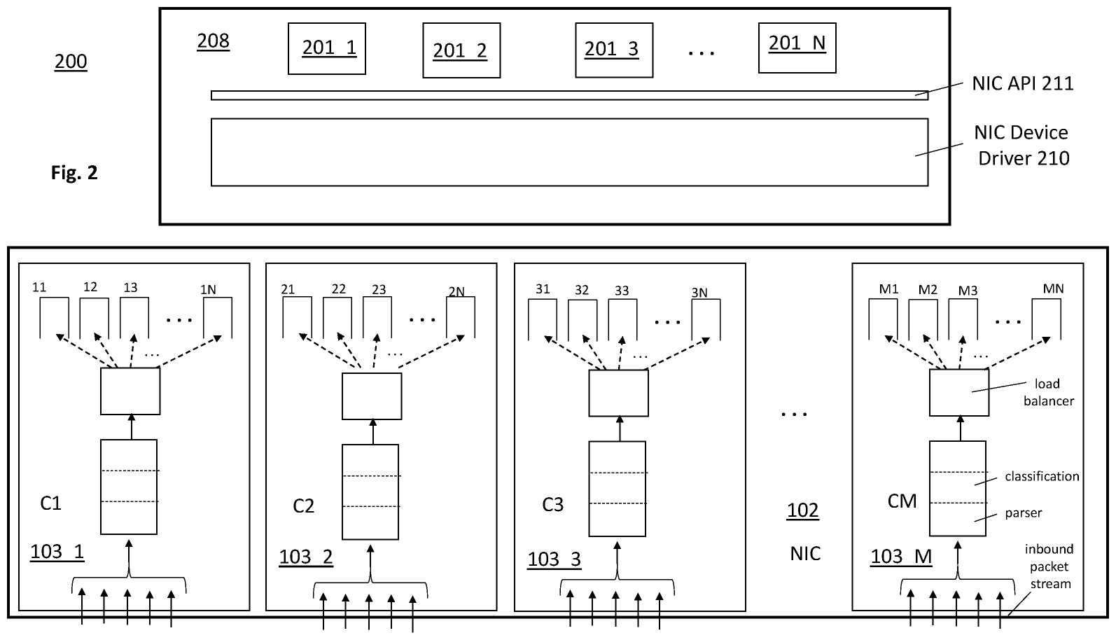

FIG. 2 shows a more detailed embodiment in which the CPUs 201_1 through 201_N are integrated on a common hardware platform 208 (“CPU platform”) such as a multicore processor, server motherboard, CPU compute blade, etc. The NIC's device driver 210 is plugged into the CPUs' operating system (not shown) and executes on one or more of the CPUs 201_1 through 201_N on the CPU platform 208. The NIC device driver 210 communicates to the operating system through a NIC Device Driver Application Programming Interface (API) 211 (“NIC API”).

As described in more detail below, in various embodiments, the device driver 210 is designed to provide, as appropriate, interrupt or polled servicing for each receive channel's N output queues. In the case of interrupt servicing, the system reacts to the arrival of packets. That is, the system services one or more packets from a queue in response to (an interrupt generated in response to) the arrival of a packet into the queue. By contrast, in the case of polling, the system proactively services a queue irrespective of the actual arrival of any packets into the queue. For example, the system will periodically “ping” a queue and if there are any packets in the queue the system will service one or more of them.

An observation is that an efficient way to service a queue is to transition from interrupt servicing to polled servicing. Here, packets typically arrive to a queue in bursts. That is, for extended periods of time a queue will be empty and does not receive any packets. In between these extended periods of time the queue will suddenly receive a large number of packets.

Under these circumstances it is more efficient to place a queue in interrupt service mode during an extended period in which the queue is empty and does not receive any packets. In this case, the system does not expend any resources pinging an empty queue (instead, in interrupt mode, the system is waiting for the actual arrival of a packet into the queue as a pre-condition for giving the queue attention).

With the queue in interrupt service mode, when a burst of packets eventually enter the queue, the system will react to the arrival of the first packet of the burst by transitioning the queue's servicing into polling mode. In polling mode, ideally, the system proactively services the burst's packets from the queue (e.g., by periodically pinging the queue until the queue is empty). When all of the burst's packets have been serviced and the queue is empty, the system transitions the queue's servicing back to interrupt mode.

Thus, ideally, the system only expends servicing resources on the queue when packets are actually entered within the queue.

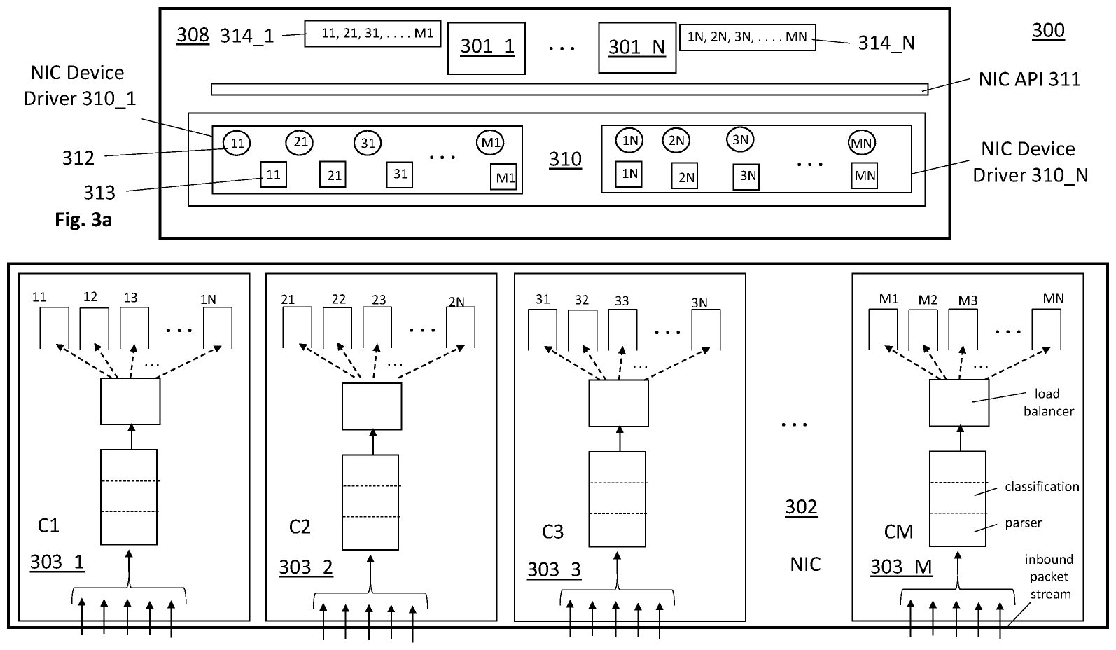

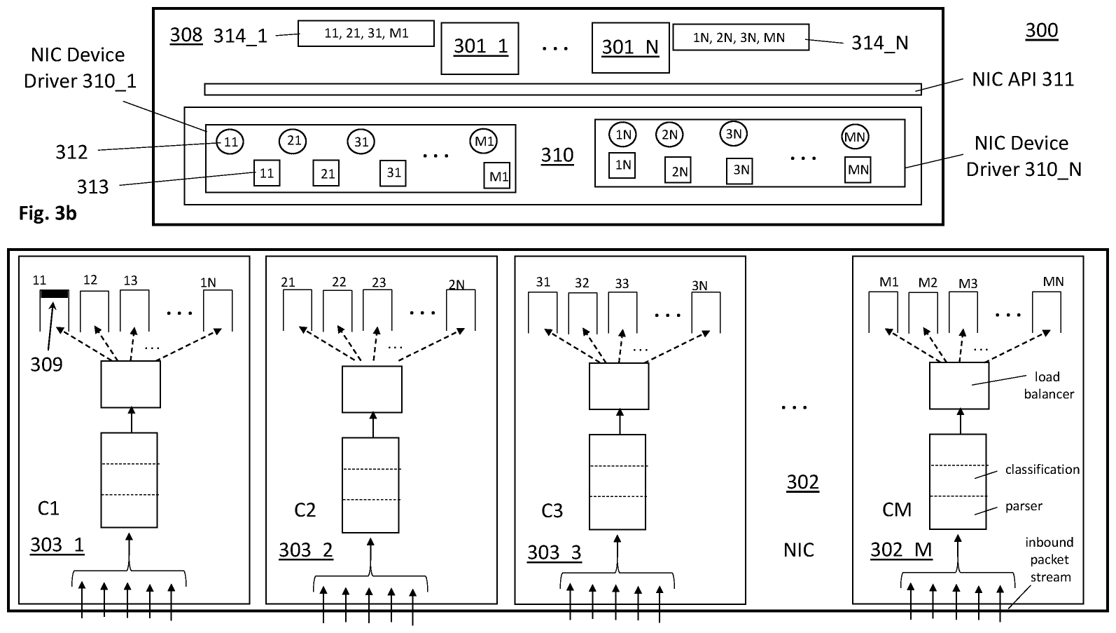

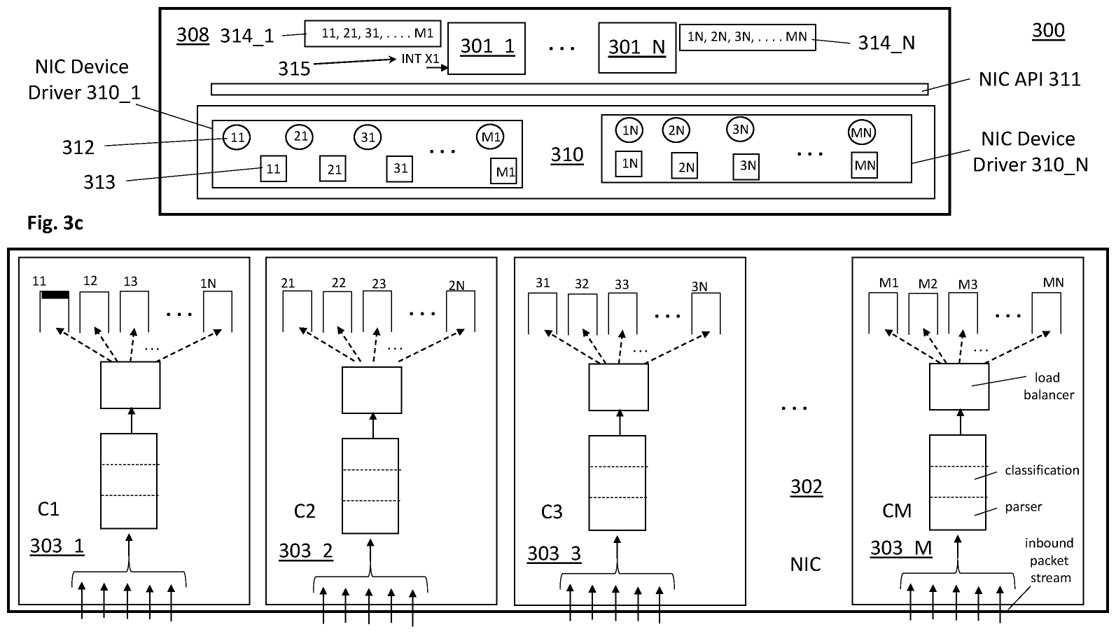

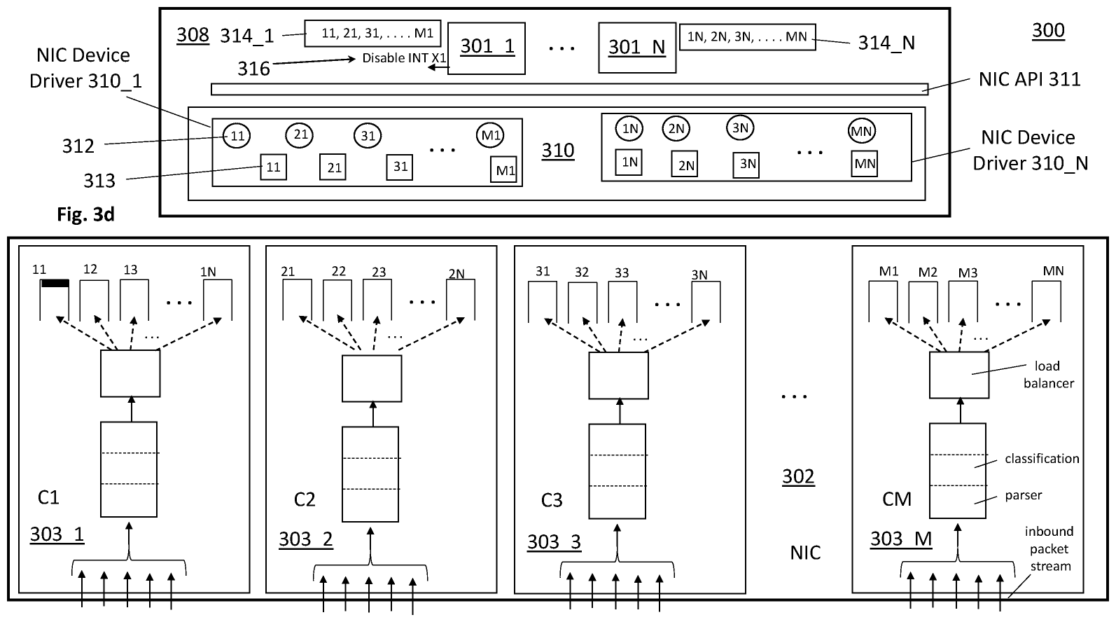

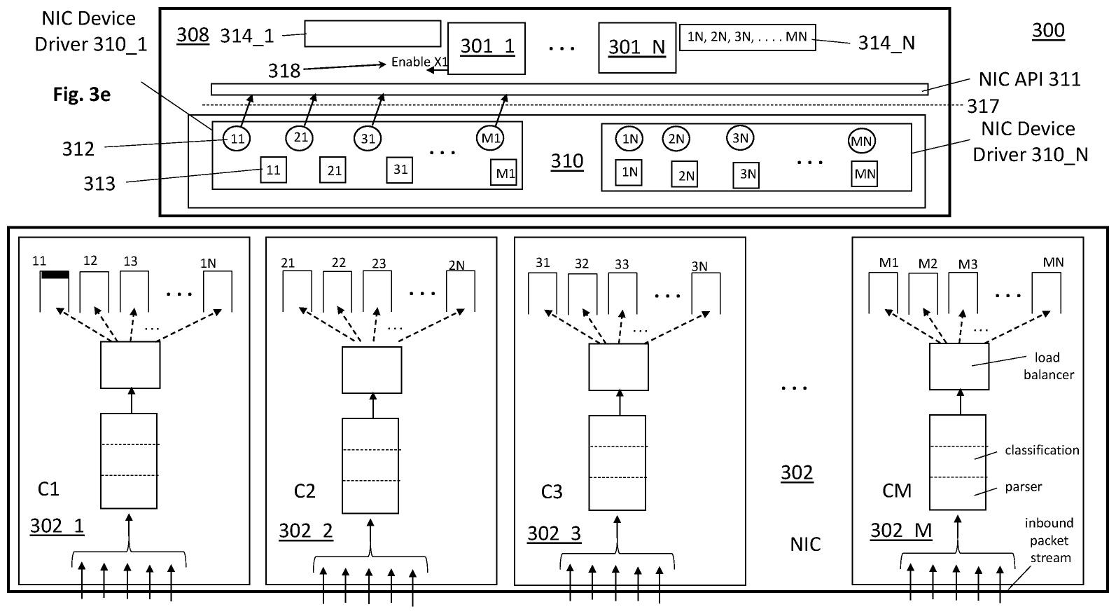

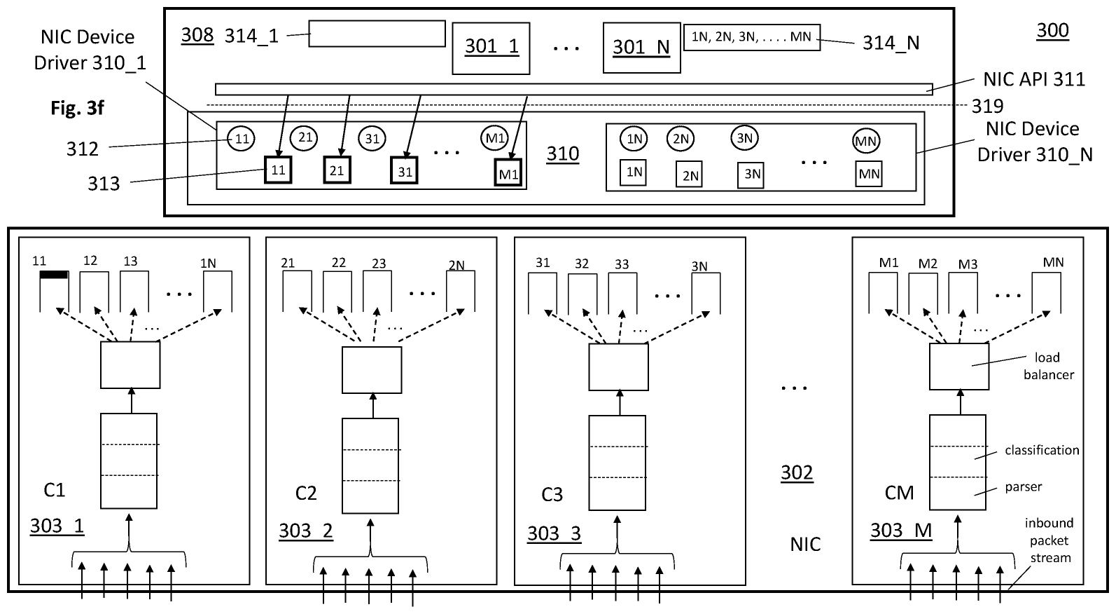

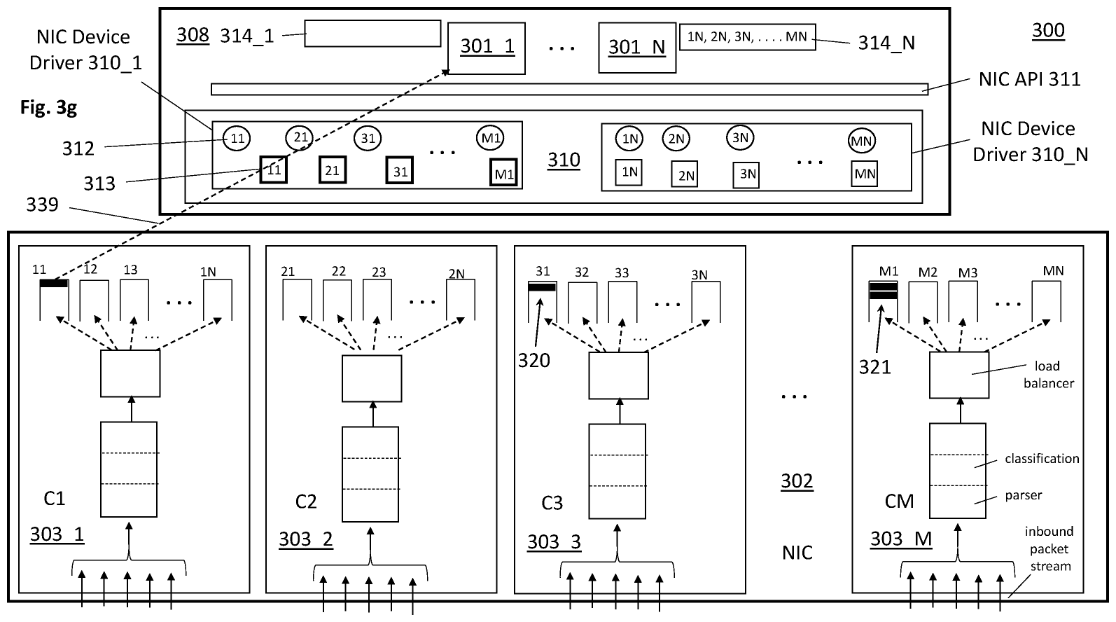

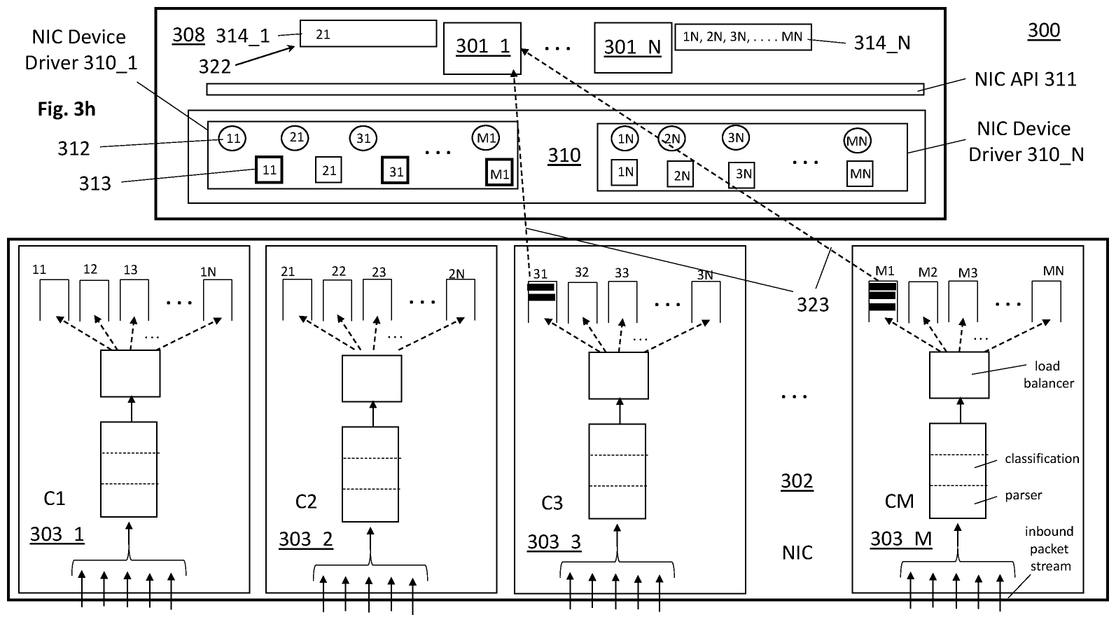

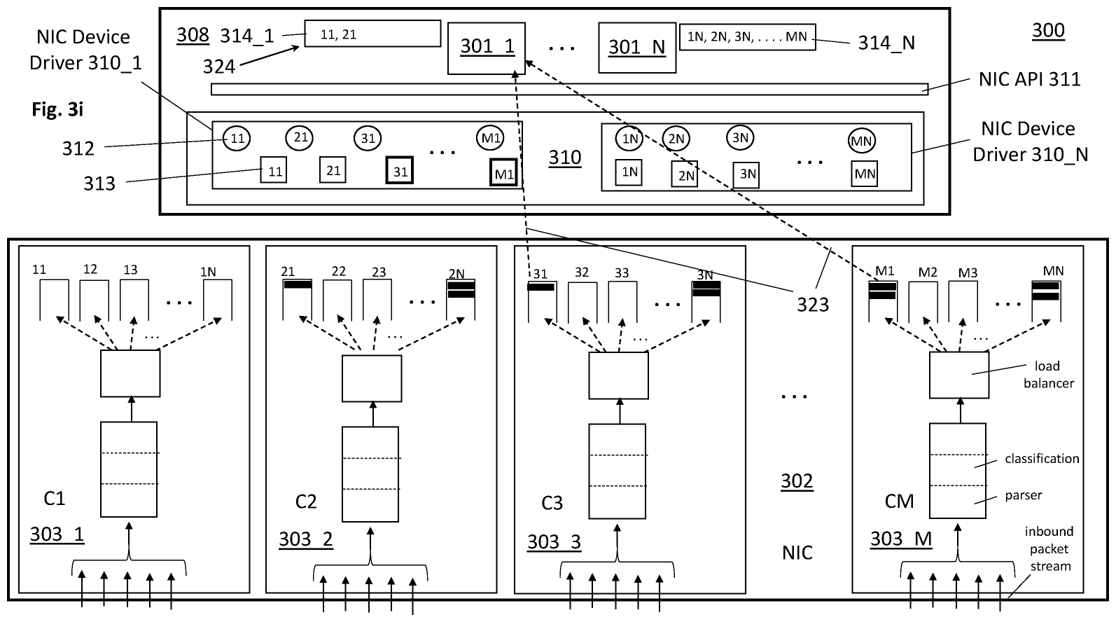

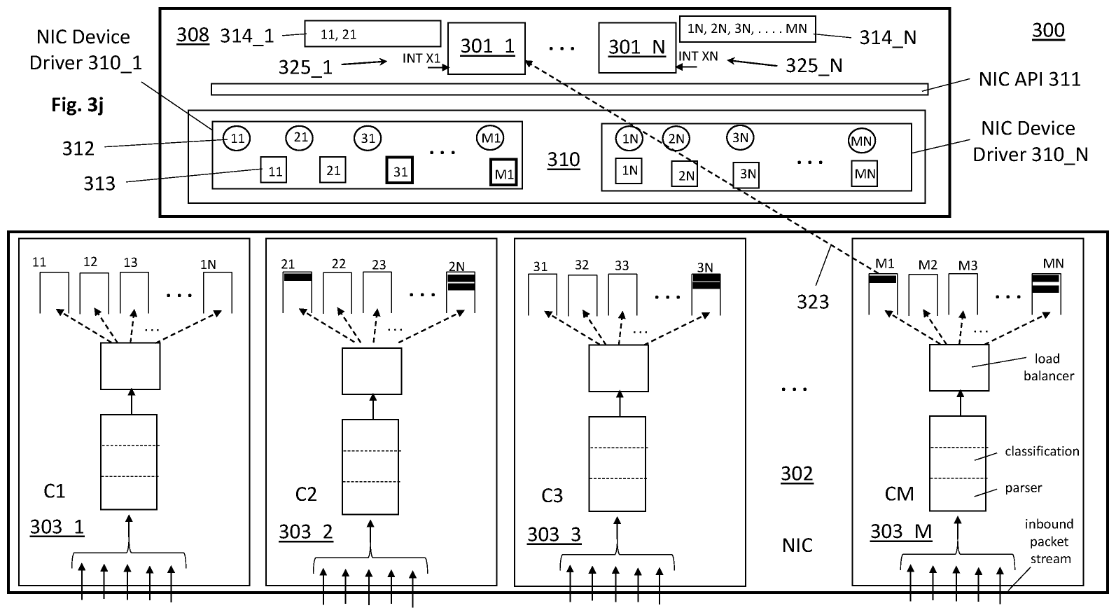

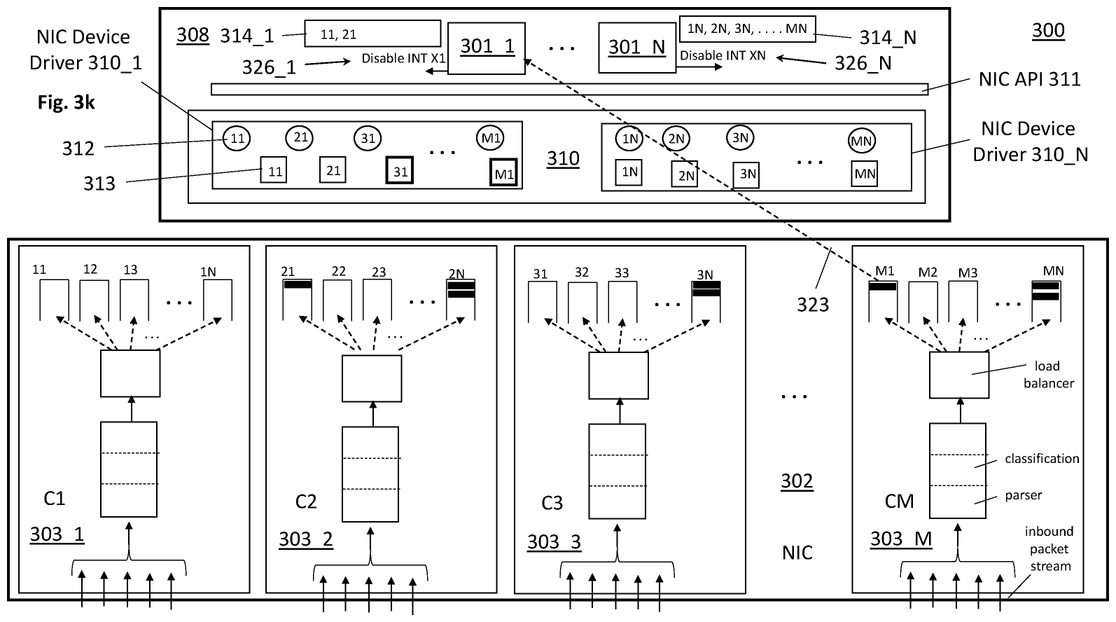

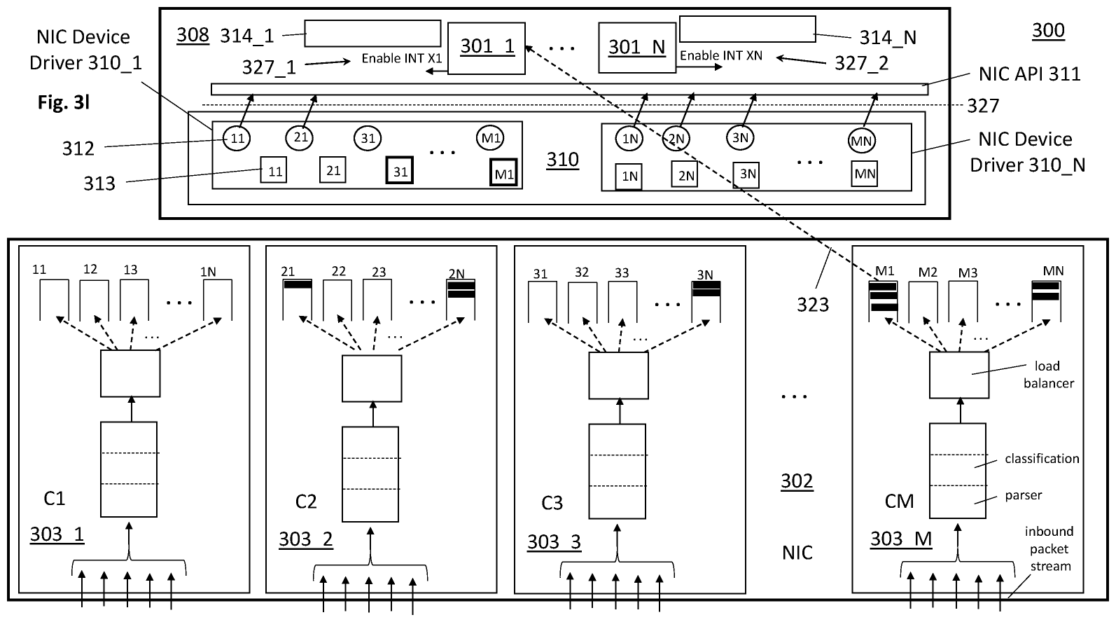

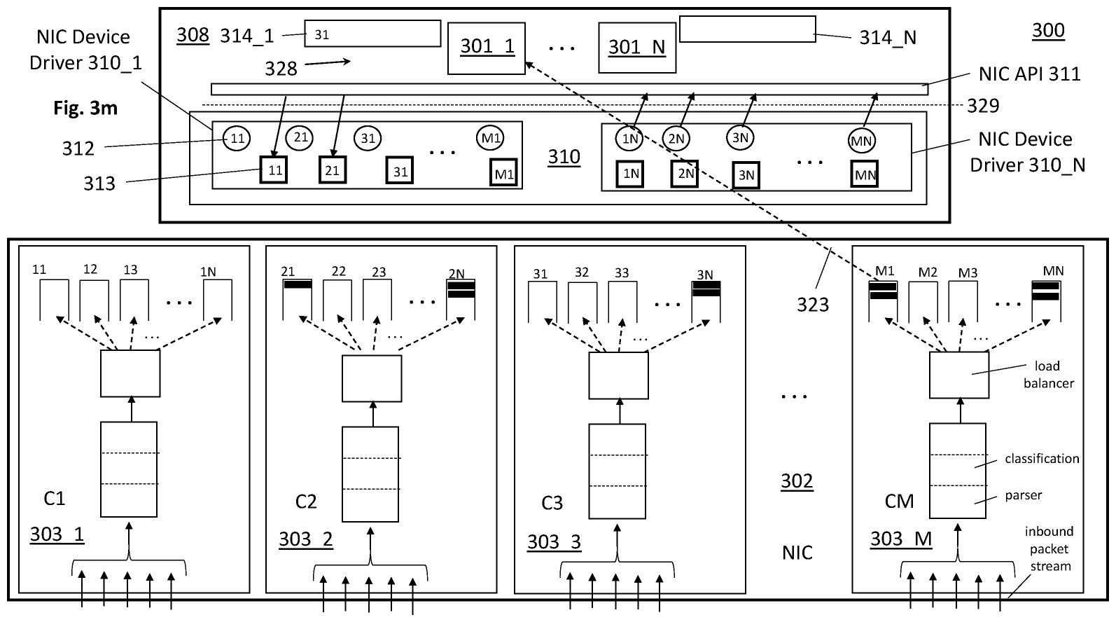

FIGS. 3a through 3m describe an embodiment of the device driver's functionality in the context of an exemplary flow of receive packets. For ease of explanation the inbound packets are placed in output queues that only target CPU 101_1 or CPU 101_N. As such, consistent with the discussion of FIGS. 1 and 2, in the example of FIGS. 3a through 3m, inbound packets only enter the first queue of any receive channel 303 or the Nth queue of any receive channel 303. The transmission of outbound packets is not addressed but is described toward the end of the instant specification.

As observed in FIG. 3a, the device driver 310 is initially configured with particular instances of data and program code 310_1, 310_N that effectively map the receive channel output queues to their corresponding CPUs. Here, as will become more clear further below, during runtime, the device driver 310 exhibits a distributed architecture is which pertinent device driver components that are associated with a specific CPU execute and/or are accessed by that CPU.

As observed in the particular embodiment of FIG. 3a, device driver components 310_1 execute on CPU 301_1 and device driver components 310_N execute on CPU 301_N. Likewise interrupt cause list 314_1 is generated by the device driver 310 (e.g., within program code of components 310_1) for use by CPU 301_1 and interrupt cause list 314_N is generated by the device driver 310 (e.g., within program code of components 310_N) for use by CPU 301_N (the purpose/use of the interrupt cause lists 314_1, 314_N is described in more detail further below). The different device driver components 310_1, 310_N have their own dedicated NIC API layer that executes on their respective CPU 301_1, 301_N.

The configuration can take place, e.g., during bring-up of system hardware and/or software in response to NIC installation, a system reboot or power-on reset event.

During configuration, in order to implement the specific queue/CPU mapping described above in FIGS. 1 and 2, where the first queue of each receive channel (queues 11, 21, 31, . . . N1) feed CPU 301_1 and the Nth queue of each receive channel (queues 1N, 2N, 3N, . . . MN) feed CPU 301_N, the device driver 310: 1) instantiates a poll object for each output queue; 2) instantiates a poll service handler for each output queue; and, 3) binds each queue's poll object to the particular CPU that the queue is supposed to feed.

As will become more clear further below, during runtime, a particular queue's poll object is accessed so that the operating system can obtain a handle to the queue's poll service handler (in this way, a queue's poll object is bound to the queue's poll service handler). A queue's poll service handler is program code that, when executed, polls the queue (e.g., periodically inquires whether the queue has any packets and, if so, services the packet from the queue). Thus, when a queue's poll object is bound to a particular CPU, the operating system will associate the queue's poll handler with the CPU, cause the poll handler to be executed on that CPU and cause packets that are serviced from the queue by the poll handler to be forwarded to the CPU (e.g., by calling functions through the NIC API layer on that CPU).

For illustrative ease, a reference number is only provided for queue 11's poll object 312 and for queue 11's poll handler. As can be seen in FIG. 3a, however, a poll object is represented as a circle with an identifier of its corresponding queue and a poll service handler is represented as a square with an identifier of its corresponding queue.

A separate interrupt cause list 314_1, 314_N is also maintained for the CPUs 301_1, 301_N. That is, cause list 314_1 identifies the queues that feed CPU 301_1 that are in interrupt mode and cause list 314_N identifies the queues that feed CPU 301_N that are in interrupt mode. As will become more clear in the following discussion, when a queue is transitioned from interrupt mode to polling mode, the identity of the queue is removed from its CPU's interrupt cause list and the operating system invokes its poll service handler.

FIG. 3a shows, e.g., an initial state after bring-up in which no packets have been received and all queues that feed CPUs 301_1 and 301_N are empty. As such, the first queue in each of the receive channels 303_1 through 303_N is identified in interrupt cause list 314_1 and the Nth queue in each of the receive channels 303_1 through 303_N is identified in interrupt cause list 314_N.

In FIG. 3b, a first packet arrives 309 in queue 11.

In response to the arrival of the packet in queue, referring to FIG. 3c, the NIC 302 generates an interrupt 315 that is presented to processor 301_1 (because the packet arrived on queue 11 which is mapped to processor 301_1). In an embodiment, there is one interrupt per CPU and any queue that feeds a particular CPU can cause the interrupt for its CPU to be raised. That is, said another way, the set of queues that feed a same CPU share a same interrupt into that same CPU.

In response to the interrupt 315, as observed in FIG. 3d, the processor 310_1 that received the interrupt executes an interrupt service routine (ISR) which immediately disables 316 the interrupt for processor CPU 301_1 (the ISR can be another program code component within device driver components 310_1). This prevents any of the other queues the feed CPU 301_1 from generating an interrupt for CPU 301_1 should any such queue imminently receive a packet. Alternatively or in combination, the NIC 302 or other hardware disables the interrupt. Thus, after the interrupt 315 is received, the hardware and/or the ISR auto disables the interrupt.

After the interrupt for CPU 301_1 has been disabled 316, as observed in FIG. 3e, the device driver component 310_1 requests 317 the operating system (through its instance of the NIC API 311) to invoke the poll handler for each queue that was listed in the interrupt cause list 314_1 for CPU 301_1 in FIG. 3d (in this particular instance, all of the queues that feed CPU 301_1). This action effectively transitions the queues that were listed in the interrupt cause list 314_1 for CPU 301_1 in FIG. 3c from interrupt mode to polling mode. As such, the device driver ISR that is executing on processor 301_1 clears the interrupt cause list 314_1 for CPU 301_1 and re-enables 318 the interrupt for CPU 301_1.

In an embodiment, in order to implement the requests 317, device driver component 310_1 passes to the operating system (through its instance of the NIC API 311) a handle to each of the respective poll objects whose respective queue was identified in the interrupt cause list 314_1 for CPU 301_1 in FIG. 3d. In response, the operating system accesses each poll object and retrieves the handle for the respective poll service handler for the poll object's corresponding queue.

With the operating system in possession of the handle for the poll service handler for the queues that have just been entered into poll mode, referring to FIG. 3f, the operating system (through the instance of the NIC API 311 that executes on CPU 301_1) invokes 319 the handlers thereby enabling them (represented in FIG. 3f with the poll service handlers for the queues that feed CPU 301_1 being visually bolded).

Subsequently, referring to FIG. 3g, the poll handler for queue 11 polls queue 11 which causes the packet in queue 11 to be transferred 339 to CPU 301_1. Additionally, as observed in FIG. 3g, additional packets arrive 320, 321 in queues 31 and M1.

Referring to FIG. 3h, the poll service handler for queue 21 “parks itself” because queue 21 never received any packets. Here, in various embodiments, a poll service handler is designed to continually poll its respective queue until the queue has been empty for some preset time interval. Once the preset time interval has passed with the queue being empty (or other low usage threshold), the queue is deemed to be “quiet” rather than “busy”. As such, the poll service handler disables itself (the poll service handler for queue 21 visually transitions to unbold) which formally causes the queue 21 to transition from poll mode to interrupt mode. As such, the identity of queue 21 is entered 322 into the interrupt cause list 314_1 for CPU 301_1.

The poll handler for queue 11 remains active in poll mode (bold in FIG. 3g) because it just serviced a packet (action 319 in FIG. 3g) and its preset time interval has not yet elapsed.

Likewise, queues 31 and M1 received their packets (in FIG. 3g) before the preset time elapsed in their respective poll service handlers. As such, the respective poll service handlers for queues 31 and M1 remain active and begin respectively transferring 323 the packets in queues 31 and M1 to CPU 301_1.

Referring to FIG. 3i, the preset time of inactivity lapses for queue 11's poll service handler (queue 11 has not received a packet since FIG. 3b). As such, queue 11's poll service handler is deactivated (becomes unbold in FIG. 3i) and the identity of queue 11 is entered 324 in the interrupt cause list 314_1 for CPU 301_1 (queue 11 transitions from polling mode to interrupt mode).

The respective poll service handlers for queues 31 and M1 remain active and continue to respectively transfer 323 packets in queues 31 and M1 to CPU 301_1.

Additionally, new packets arrive in queues 21, 2N, 3N and MN. Notably, queue 21 feeds CPU 301_1 whereas queues 2N, 3N and MN feed CPU 301_2.

As such, referring to FIG. 3j, the NIC generates interrupts 325_1, 325_N for both CPU 301_1 (“INT_X1”) and CPU 301_N (“INT_XN”). Queue 31 becomes empty of packets owing to the continued polling of its poll service handler. The time period of inactivity for queue 31 however has not yet elapsed. As such, the poll service handler for queue 31 remains active (remains bolded in FIG. 3j). The poll service handler for queue M1 continues to service 323 packets from queue M1.

In response to the interrupts 325, referring to FIG. 3k, the respective device driver ISRs of processors 301_1 and 301_N disable 326_1, 326_N the interrupts for their respective CPUs 301_1, CPU 301_N, and/or, the NIC hardware auto disables the interrupts 325 after generating them. Here, the same process 316 of FIG. 3d is followed but for two CPUs rather than one CPU because the NIC generated two interrupts in FIG. 3i.

The time period of inactivity for queue 31 has still not elapsed. As such, the poll service handler for queue 31 remains active (remains bolded in FIG. 3k). The poll service handler for queue M1 continues to service 323 packets from queue M1.

Referring to FIG. 3l, in response to the interrupts 325_1, 325_N of FIG. 3k, device driver component 310_1 requests 327 the operating system (through its respective instance of the NIC API 311) to enable the respective poll service handlers for queues 11 and 21 (that feed CPU 301_1) and device driver component 310_N requests 327 the operating system (through its respective instance of the NIC API 311) to enable the respective poll service handlers for queues 1N, 2N, . . . MN (that feed CPU 301_N). This marks the transition of these queues from interrupt mode to polling mode. As such, the interrupt cause lists 314_1 and 314_N for both CPUs 301_1 and 301_N are cleared and the interrupts for CPUs 301_1 and 301_N are enabled 327. Here, the same process as FIG. 3e is performed except for a limited set of queues that feed CPU 301_1 and for all the queues that feed CPU 301_N.

The time period of inactivity for queue 31 has still not elapsed. As such, the poll service handler for queue 31 remains active (remains bolded in FIG. 3l). Queue M1 receives more packets. As such, the poll service handler for queue M1 remains active and continues to transfer 323 packets from queue M1 to CPU 301_1.

Referring to FIG. 3m, the preset time of inactivity lapses for queue 31's poll service handler (queue 31 has not received a packet since FIG. 3h). As such, queue 31's poll service handler is deactivated (becomes un-bolded in FIG. 3) and the identity of queue 31 is entered 328 in the interrupt cause list 314_1 for CPU 301_1 (queue 31 transitions from polling mode to interrupt mode).

The operating system (through the instance of NIC API 311 associated with device driver components 301_N) invokes 329 the poll service handlers for queues 11, 21 and 1N through MN thereby enabling them (represented in FIG. 3m with the poll service handlers for these queues being visually bolded).

The poll service handler for queue M1 remains active and continues to transfer 323 packets from queue M1 to CPU 301_1.

The process then continues as described above with the respective service poll handlers for queues 1N, 2N . . . MN that feed CPU 301_N remaining active until their respective queues are empty for a preset time interval, in which case, the service poll handler will be disabled and the identity of its respective queue entered in the interrupt cause list for CPU 301_N, and, likewise for the respective service poll handlers of queues 11, 21 and M1 that feed CPU 301_1.

In various embodiment, each service poll handler is configured (e.g., by the operating system through the NIC API 311) with a maximum number of packets and/or amount of data (“buffers”) that are allowed to be serviced by the service poll handler during a single instance of the service poll handler being enabled. In the situation where the service poll handler reaches such a maximum (in the example described above the service poll handler for queue M1 could reach its limit), the service poll handler is disabled but the operating system is informed (by the device driver 310 through the NIC API 311) that packets/buffers remain in the service poll handler's queue.

In this case, the queue remains in polling mode and the operating system, which is responsible for overseeing the total flow of packets/buffers from the NIC 302 to the CPUs 301 can, if it chooses to, e.g., opportunistically and proactively reschedules use of the queue's service poll handler without an interrupt as a precondition.

As mentioned above, in various embodiments, the NIC provides packet flow classification and/or physical and data link layer protocol functions whereas the CPUs perform MPLS or other routing function. In this configuration, after the CPUs have processed the inbound packets that were received by the NIC, the packets become outbound packets that need to be transmitted from the NICs outbound ports (additionally and/or alternatively, software executing on the CPUs 301 can originate/create packets that are sent, e.g., into a network, from the NIC). Here, as part of their packet processing, the CPUs identify which of the NIC's output ports each outbound packet is to be transmitted from and cause each outbound packet to be directed to its correct output port. The NIC then transmits the outbound packet, e.g., into a network, from the particular one of the NIC's M output ports that the packet was directed to.

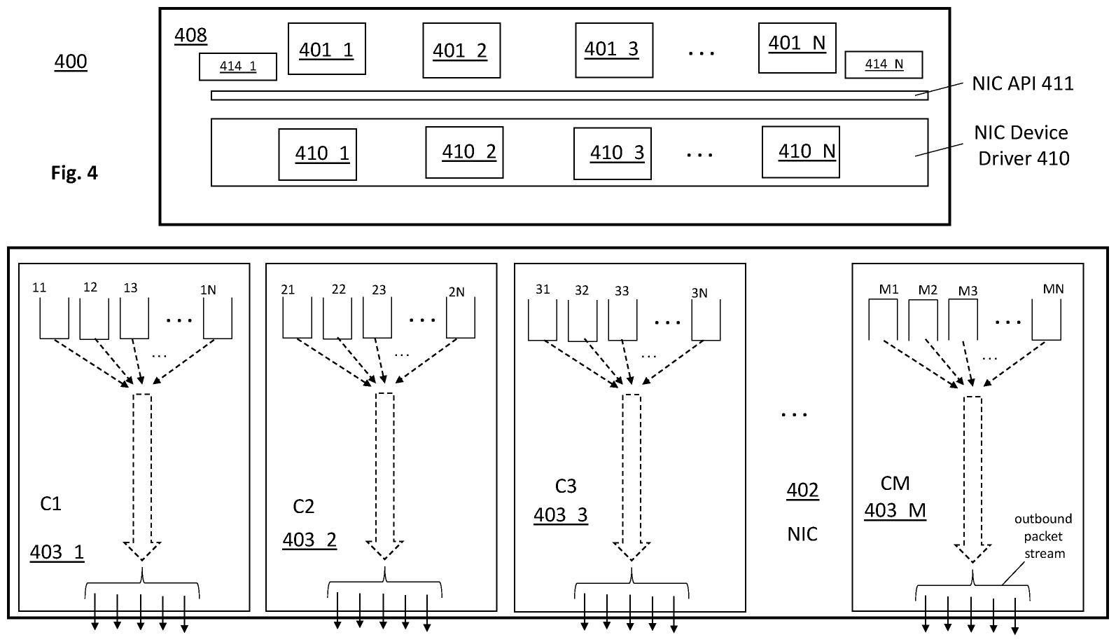

FIG. 4 shows an embodiment of a system for feeding M NIC output ports from N CPUs 401_1, 401_2, 401_3, . . . 401_N that are generating outbound packets as a consequence of the CPUs' processing of the NIC's inbound packets and/or the CPUs originating/creating them. As observed in FIG. 4 the NIC 402 has M output ports 403_1 through 403_M. The NIC output ports 403_1 through 403_M each include N transmit queues that can be bound to any one of CPUs 401_1 through 401_N. Here, when a CPU (and/or the network layers running on the CPU) has finished processing an inbound packet and has thereby converted the inbound packet into an outbound packet, or when the CPU creates a packet, the CPU places the outbound packet into the NIC transmit queue that the CPU has been bound to. The NIC then services the packet from the transmit queue for transmission from the system, e.g., into a network.

Referring to FIG. 4, the operation and architecture of the NIC device driver 410 for outbound packets can be similar to the operation and architecture of the NIC 402 described above with respect to FIGS. 3a through 3m for inbound packets. That is, the device driver 410 creates a poll object and poll handler for all N queues per transmit channel 403 for all N CPUs. During configuration, the poll objects and poll handlers for a particular NIC transmit queue are bound to a particular CPU.

As alluded to just above, the CPUs feed packets into the respective inbound transmission queues 11 through MN on the NIC 402 that they are bound to. The packets are then serviced from their respective queues by the NIC 402 and sent (e.g., into a network) from the system. Here, however, rather than entry of a packet into a queue being the critical event that triggers the behavior of the process, instead, the successful transmission of a packet from the NIC, which has the effect of removing the packet from its particular one of inbound transmission queues (e.g., by marking the packet TRANSMIT-COMPLETE which allows the packet to be written over by a new packet in the queue) is the critical event that triggers the behavior of the process.

For example, when a transmit queue is deemed quiet for a sufficient amount of time, the queue is placed into interrupt mode and its identity is entered into its CPU's cause list (the queue can be empty or contain packets because it is the attention given to the queue by the NIC that determines whether the queue is busy or not). In this state, the operating system can provide packets to the queue up to the queue's maximum capacity. Once the NIC services a next packet from the queue, however, an interrupt is generated which causes the queue's poll handler to be activated. Here, the device driver and operating system are awakened to the fact that the NIC is now giving the queue attention (is servicing packets from the queue) and so the software polls the queue so that, e.g., more outbound packets can be entered into the queue as the NIC services packets from the queue.

In various embodiments the NIC API 311, 411 is compliant with a Network Driver Interface Specification (NDIS) specification (e.g., a Microsoft NDIS specification, an NDISwrapper specification, etc.) or combination of NDIS specifications.

In such embodiments, the aforementioned poll objects are implemented with NDIS_POLL_CHARACTERISTICS data structures. During configuration/initialization of the NIC, the device driver creates a separate NDIS_POLL_CHARACTERISTICS data structure for each NIC receive channel output queue and/or each CPU transmit queue. The NDIS_POLL_CHARACTERISTICS data structure includes the device driver entry point that the operating system is to use when invoking the NDIS_POLL_CHARACTERISTICS data structure's corresponding poll service handler (that is, the poll service handler that is to perform poll servicing of the queue that the NDIS_POLL_CHARACTERISTICS data structure was created for).

After the device driver creates an NDIS_POLLCHARACTERISTICS data structure for a particular queue, as part of the NIC's configuration/initialization, the device driver registers (through the NDIS interface) the NDIS_POLL_CHARACTERISTICS data structure with the operating system (e.g., NDISRegisterPoll function is called through the NDIS interface).

In response, the operating system returns to the device driver through the NDIS interface a name (“handle”) for the NDIS_POLL_CHARACTERISTICS data structure that the NIC's device driver is to use when referring the NDIS_POLL_CHARACTERISTICS data structure to the operating system. The device driver 310 then binds the handle with a particular one of the CPUs 301 through the NIC API 311 (e.g., the device driver calls the NdisSetPollAffinity function of the NDIS interface which includes as input variables the handle for the NDIS_POLL_CHARACTERISTICS data structure and an identity of the CPU that the handle is to be bound with) which effectively binds the NDIS_POLL_CHARACTERISTICS data structure and its corresponding queue to a particular CPU.

Also during configuration/initialization, an NDIS_POLL_DATA data structure is created (e.g., by the operating system) for each poll service handler (e.g., an NDIS_POLL_RECEIVE_DATA data structure is created for each NIC receive channel output queue poll service handler and/or an NDIS_POLLTRANSMIT_DATA data structure is created for each CPU transmit queue poll service handler). The NDIS_POLL_DATA data structure includes a parameter (e.g., MaxNblsTolndicate) that sets a maximum limit of packets/buffers that the poll service handler can service during a single instance of the poll handler's enablement. The NDIS_POLL_DATA data structure also includes a parameter (NumberOflndicatedNBLs) that the poll service handler can use to inform the operating system that packets/buffers remain in the queue after the maximum has been reached.

During runtime, when an interrupt is generated that invokes a particular interrupt cause list that includes the identity of a particular queue, the device driver passes the handle for the queue's NDIS_POLL_CHARACTERISTICS data structure to the operating system through the NDIS interface (e.g., the device driver calls an NdisRequestPoll function through the NDIS API that includes the handle). In response, the operating system accesses the NDIS_POLL_CHARACTERISTICS data structure to obtain the device driver entry point for the queue's corresponding poll service handler.

The operating system then invokes/enables the queue's poll service handler and passes to the device driver (through the NDIS interface) a pointer to the poll service handler's NDIS_POLL_DATA data structure (e.g., the operating system calls the device driver's NdisPoll function at the device driver entry point identified in the NDIS_POLL_CHARACTERISTICS data structure, and, includes as a parameter of the NdisPoll function the pointer to the NDIS_POLL_DATA data structure). The NDIS interface will keep invoking the poll service handler (e.g., will keep invoking NdisPoll) while the driver is making forward progress (is servicing packet's from its queue). Because the device driver bound the NDIS_POLL_CHARACTERISTICS data structure with a particular CPU during initialization/configuration of the NIC, the operating system ensures that the NDISPoll handler is invoked on that queue so that packets are forwarded to the particular CPU and/or the CPU's memory (The NDISPoll handler is invoked on a particular queue on the CPU that it is affinitized to so that packets are processed in the handler on that CPU).

In various embodiments, whether an NDIS API is used or is not used, the NIC performs direct memory access (DMA) transfers as commanded by the device driver's poll service handlers to service the queues. In the receive direction, the DMA transfers remove packets/buffers from queues that exist on the NIC and place them into memory that the device driver and operating system execute from. In the transmit direction, the DMA transfers remove packets/buffers from queues that are implemented within a memory that the device driver and operating system execute from and place them into an outbound queue that exists on the NIC.

In various embodiments, the aforementioned operating system that communicates with the NIC device driver 310, 410 through the NIC API 311, 411 is a multiprocessor operating system (e.g., Windows NT, Unix, Linux, etc.) that supports the concurrent operation of the N multiple CPUs 301, 401 and effectively executes upon the N multiple CPUs 301, 401, e.g., in a distributed fashion. Likewise, the device driver 310, 410 can also execute upon the N multiple CPUs 301, 401 in a distributed fashion.

In other environments, both the operating system that communicates with the device driver 310, 410 and the device driver 310, 410 are centralized and execute upon a single CPU. In this case the CPU that executes the operating system and device driver 310, 410 can be a CPU other than the N CPUS 301, 401, or, can be one of the N CPUs 301, 401. In the centralized approach, the operating system that communicates with the NIC device driver 310, 410 communicates with the respective operating systems of other CPUs that process the NIC's packets to logically connect the NIC with these other CPUs.

The interrupt cause lists 314, 414 can be written into register space of their respective CPU(s) 301_1 through 301_N, 401_1 through 401_N that execute the respective device driver components 310_1 through 310_N, 410_1 through 410_N and/or be stored in memory that the CPU(s) 301_1 through 301_N, 401_1 through 401_N respectively execute out of. In various embodiments, the NIC device driver determines the interrupt causes lists and makes copies of them available to their respective CPUs 301_1 through 301_N, 401_1 through 401_N by programming them into the CPUs 301_1 through 301_N or storing them in memory that the CPUs 301_1 through 301_N, 401_1 through 401_N respectively execute out of. The device drivers can also keep the cause lists in register space on the NIC.

Referring back to FIG. 1, it is pertinent to recognize that other NIC architectures are possible. For example, in various embodiments, a single packet processing pipeline can feed more than N queues (i.e., more queues than the number of CPUs that process the NIC's packets). For example, the hash used in the pipeline's RSS function may identify more than N queues which results in the pipeline identifying more than one queue per CPU. In this case multiple queues that are fed by a same pipeline can be bound to a same CPU.

In still other configurations, the packet classification function of a pipeline assigns unique “flows” to unique inbound packet streams (e.g., packet streams having same TCP/IP header information belong to a same flow) and a unique output queue is created for each flow. In this case there can be many more flows and corresponding output queues than CPUs. Thus, again, multiple queues that are fed by a same pipeline can be bound to a same CPU.

FIG. 5 shows an embodiment of an ingress packet processing pipeline 503. As observed in FIG. 5, the packet processing pipeline 503 is used to process inbound packets and assign each inbound packet to an appropriate queue. Generally, the pipeline 503 includes a stage 504 at (or toward) the pipeline's front end that parses a packet's header and extracts information found in the header's various fields.

The pipeline 503 also includes another stage 505 that identifies the flow that the inbound packet belongs to or otherwise “classifies” the packet for its downstream treatment or handling (“packet classification”). Here, the extracted packet header information (or portion(s) thereof) is compared against entries in a table 508 of looked for values. The particular entry whose value matches the packet's header information identifies the flow that the packet belongs to or otherwise classifies the packet.

The packet processing pipeline 503 also includes a stage 506 at (or toward) the pipeline's back end that, based on the content of the inbound packet's header information (typically the port and IP address information of the packet's source and destination), directs the packet to a particular one of the queues 502_1 through 502_N.

Typically, packets having the same source and destination header information are part of a same flow and will be assigned to the same queue. With each queue being associated with a particular quality of service (e.g., queue service rate), switch core input port or other processing core, the forwarding of inbound packets having same source and destination information to a same queue effects a common treatment to packets' belonging to a same flow.

Recall from the discussion of FIG. 1 that a load balancer 106 can be inserted between the packet processing pipeline 105 and the queues, and, notably, FIG. 5 does not depict a load balancer between the last pipeline stage 506 and the queues 502. In various embodiments a load balancer can be integrated into (e.g., as a last stage of) the pipeline 503, or, the pipeline 503 can feed a separate load balancer that is inserted between the pipeline 503 and the queues.

Moreover, in various embodiments, as suggested by FIG. 1, the packet processing pipeline 503, load balancer (whether integrated with the pipeline 503 or separate from the pipeline 503) and queues 502 are all integrated on a common NIC 102 hardware platform. For example, the NIC 102 is a single plug-in module, card, board or system that plugs into a backplane or rack and includes the pipeline 502, load balancer and queues 502.

In other embodiments, however, more than one hardware element is used to implement the pipeline 503, load balancer and queues 502 (the NIC). For example, a first plug-in module/card/board/system only includes the pipeline 503, and, a second plug-in module/card/board/system includes the load balancer and queues. Alternatively, a first plug-in module/card/board/system only includes the pipeline 503 and load balancer, and, a second plug-in module/card/board/system includes the queues.

As discussed above with respect to FIG. 1, in various embodiments the load balancer performs receive side scaling (RSS). In the case of RSS, a hash is performed with a (e.g., Toeplitz) hash key and a packet's flow related header information (e.g., as identified by a three tuple (source IP address, destination IP address and protocol) for layer 3 flows, or a three tuple and source port and destination port information for layer 4 flows). The hashing operation generates a hash signature which can be used to identify a particular queue (explicitly or impliedly by correlating specific hash signature values to specific queues).

Here, hashes performed on packets belonging to a same flow will have same packet header information and therefore will generate same hash signatures. As such, packets belonging to a same flow will be placed into a same queue. By contrast, packets belonging to different flows (and therefore having different header information) will generate different hash signatures and will be placed in different queues. The hash key is designed to (ideally) evenly spread hash signatures from packet header space across the different queues, thereby effecting load balancing. However in actual implementation there can be some unevenness.

In various embodiments, the CPUs 301_1 through 301_N of FIGS. 3a-m and 401_1 through 401_N of FIG. 4 are NIC 302, 402 are components in a traditional computer system (such as a server). In this case, the CPUs 301, 401 can be, e.g., processing cores on a same general purpose multicore processor and/or different general purpose multicore processor. Here, the CPUs 301, 401 are integrated on a motherboard and the NIC 302, 402 plugs into the motherboard. In disaggregated computing environments, the CPUs 301, 401 can be integrated within a CPU blade server that, e.g., plugs into a rack and the NIC 302, 402 can be a separate unit that plugs into the same rack or a different rack. Whether a traditional or disaggregated approach is pursued, the CPUs 301, 401 and NIC 302, 402 can be communicatively coupled by a one or more networks, one or more point-to-point links or any combination thereof.

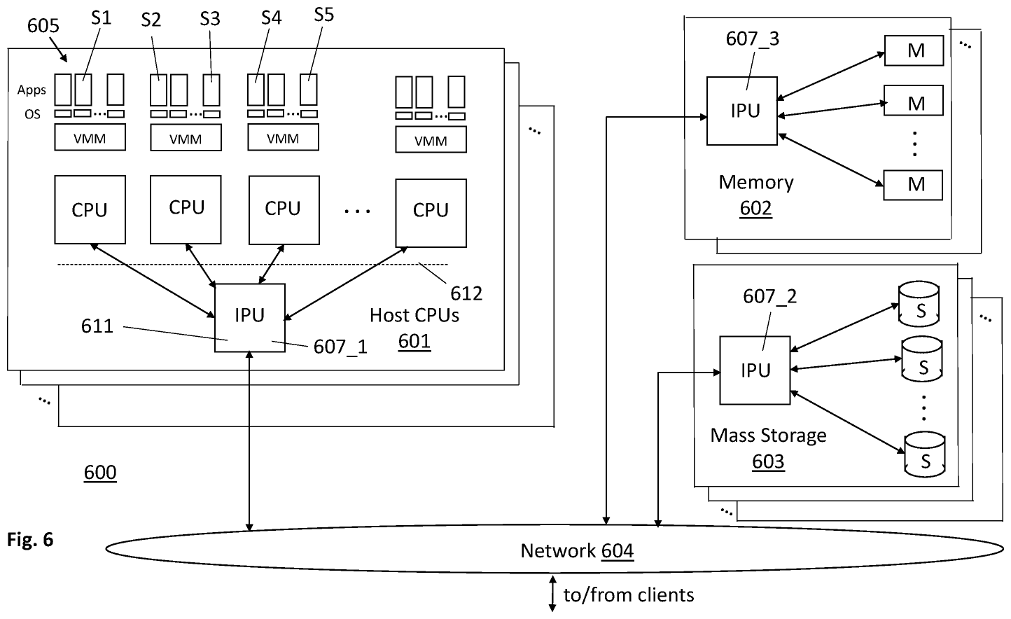

In various computing environments, particularly within a data center environment, the CPUs 301, 401 and NIC 302, 402 are integrated within an infrastructure processing unit (IPU). FIG. 6 shows a new, emerging data center environment in which “infrastructure” tasks are offloaded from traditional general purpose “host” CPUs (where application software programs are executed) to an infrastructure processing unit (IPU) or data processing unit (DPU) any/all of which are hereafter referred to as an IPU.

Networked based computer services, such as those provided by cloud services and/or large enterprise data centers, commonly execute application software programs for remote clients. Here, the application software programs typically execute a specific (e.g., “business”) end-function (e.g., customer servicing, purchasing, supply-chain management, email, etc.). Remote clients invoke/use these applications through temporary network sessions/connections that are established by the data center between the clients and the applications. A recent trend is to strip down the functionality of at least some of the applications into more finer grained, atomic functions (“micro-services”) that are called by client programs as needed. Micro-services typically strive to charge the client/customers based on their actual usage (function call invocations) of a micro-service application.

In order to support the network sessions and/or the applications' functionality, however, certain underlying computationally intensive and/or trafficking intensive functions (“infrastructure” functions) are performed.

Examples of infrastructure functions include routing layer functions (e.g., IP routing), transport layer protocol functions (e.g., TCP), encryption/decryption for secure network connections, compression/decompression for smaller footprint data storage and/or network communications, virtual networking between clients and applications and/or between applications, packet processing, ingress/egress queuing of the networking traffic between clients and applications and/or between applications, ingress/egress queueing of the command/response traffic between the applications and mass storage devices, error checking (including checksum calculations to ensure data integrity), distributed computing remote memory access functions, etc.

Traditionally, these infrastructure functions have been performed by the CPU units “beneath” their end-function applications. However, the intensity of the infrastructure functions has begun to affect the ability of the CPUs to perform their end-function applications in a timely manner relative to the expectations of the clients, and/or, perform their end-functions in a power efficient manner relative to the expectations of data center operators.

As such, as observed in FIG. 6, the infrastructure functions are being migrated to an infrastructure processing unit (IPU) 607. FIG. 6 depicts an exemplary data center environment 600 that integrates IPUs 607 to offload infrastructure functions from the host CPUs 604 as described above.

As observed in FIG. 6, the exemplary data center environment 600 includes pools 601 of CPU units that execute the end-function application software programs 605 that are typically invoked by remotely calling clients. The data center also includes separate memory pools 602 and mass storage pools 605 to assist the executing applications. The CPU, memory storage and mass storage pools 601, 602, 603 are respectively coupled by one or more networks 604.

Notably, each pool 601, 602, 603 has an IPU 607_1, 607_2, 607_3 on its front end or network side. Here, each IPU 607 performs pre-configured infrastructure functions on the inbound (request) packets it receives from the network 604 before delivering the requests to its respective pool's end function (e.g., executing application software in the case of the CPU pool 601, memory in the case of memory pool 602 and storage in the case of mass storage pool 603).

As the end functions send certain communications into the network 604, the IPU 607 performs pre-configured infrastructure functions on the outbound communications before transmitting them into the network 604. The communication 612 between the IPU 607_1 and the CPUs in the CPU pool 601 can transpire through a network (e.g., a multi-nodal hop Ethernet network) and/or more direct channels (e.g., point-to-point links) such as Compute Express Link (CXL), Advanced Extensible Interface (AXI), Open Coherent Accelerator Processor Interface (OpenCAPI), Gen-Z, etc.

Depending on implementation, one or more CPU pools 601, memory pools 602, mass storage pools 603 and network 604 can exist within a single chassis, e.g., as a traditional rack mounted computing system (e.g., server computer). In a disaggregated computing system implementation, one or more CPU pools 601, memory pools 602, and mass storage pools 603 are separate rack mountable units (e.g., rack mountable CPU units, rack mountable memory units (M), rack mountable mass storage units (S)).

In various embodiments, the software platform on which the applications 605 are executed include a virtual machine monitor (VMM), or hypervisor, that instantiates multiple virtual machines (VMs). Operating system (OS) instances respectively execute on the VMs and the applications execute on the OS instances. Alternatively or combined, container engines (e.g., Kubernetes container engines) respectively execute on the OS instances. The container engines provide virtualized OS instances and containers respectively execute on the virtualized OS instances. The containers provide isolated execution environment for a suite of applications which can include, applications for micro-services.

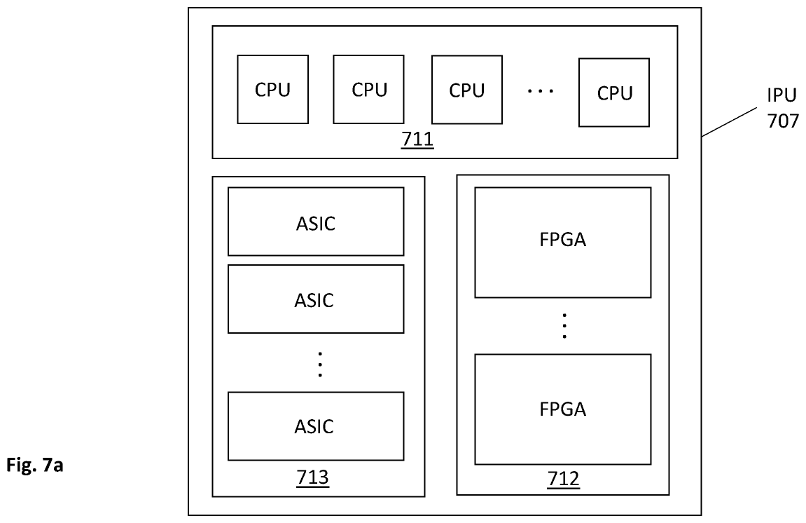

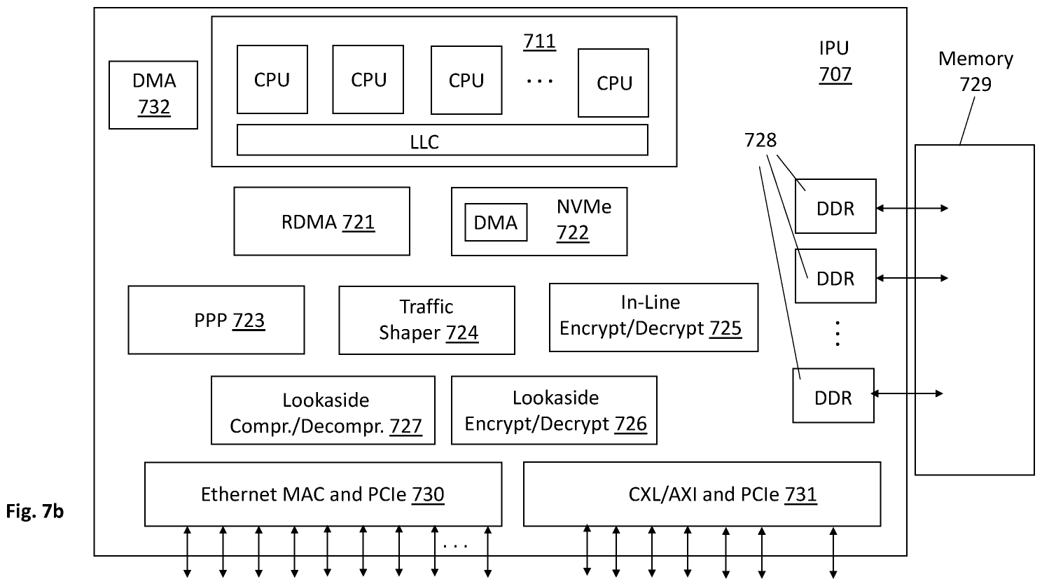

FIG. 7a shows an exemplary IPU 707. As observed in FIG. 7 the IPU 707 includes a plurality of general purpose processing cores 711, one or more field programmable gate arrays (FPGAs) 712, and/or, one or more acceleration hardware (ASIC) blocks 713. An IPU typically has at least one associated machine readable medium to store software that is to execute on the processing cores 711 and firmware to program the FPGAs (if present) so that the processing cores 711 and FPGAs 712 (if present) can perform their intended functions.

The IPU 707 can be implemented with: 1) e.g., a single silicon chip that integrates any/all of cores 711, FPGAs 712, ASIC blocks 713 on the same chip; 2) a single silicon chip package that integrates any/all of cores 711, FPGAs 712, ASIC blocks 713 on more than chip within the chip package; and/or, 3) e.g., a rack mountable system having multiple semiconductor chip packages mounted on a printed circuit board (PCB) where any/all of cores 711, FPGAs 712, ASIC blocks 713 are integrated on the respective semiconductor chips within the multiple chip packages.

The processing cores 711, FPGAs 712 and ASIC blocks 713 represent different tradeoffs between versatility/programmability, computational performance and power consumption. Generally, a task can be performed faster in an ASIC block and with minimal power consumption, however, an ASIC block is a fixed function unit that can only perform the functions its electronic circuitry has been specifically designed to perform.

The general purpose processing cores 711, by contrast, will perform their tasks slower and with more power consumption but can be programmed to perform a wide variety of different functions (via the execution of software programs). Here, the general purpose processing cores can be complex instruction set (CISC) or reduced instruction set (RISC) CPUs or a combination of CISC and RISC processors.

The FPGA(s) 712 provide for more programming capability than an ASIC block but less programming capability than the general purpose cores 711, while, at the same time, providing for more processing performance capability than the general purpose cores 711 but less than processing performing capability than an ASIC block.

FIG. 7b shows a more specific embodiment of an IPU 707. The particular IPU 707 of FIG. 7b does not include any FPGA blocks. As observed in FIG. 7b the IPU 707 includes a plurality of general purpose cores 711 and a last level caching layer for the general purpose cores 711. The IPU 707 also includes a number of hardware ASIC acceleration blocks including: 1) an RDMA acceleration ASIC block 721 that performs RDMA protocol operations in hardware; 2) an NVMe acceleration ASIC block 722 that performs NVMe protocol operations in hardware; 3) a packet processing pipeline ASIC block 723 that parses ingress packet header content, e.g., to assign flows to the ingress packets, perform network address translation, etc.; 4) a traffic shaper 724 to assign ingress packets to appropriate queues for subsequent processing by the IPU 707; 5) an in-line cryptographic ASIC block 725 that performs decryption on ingress packets and encryption on egress packets; 6) a lookaside cryptographic ASIC block 726 that performs encryption/decryption on blocks of data, e.g., as requested by a host CPU 301; 7) a lookaside compression ASIC block 727 that performs compression/decompression on blocks of data, e.g., as requested by a host CPU 601; 8) checksum/cyclic-redundancy-check (CRC) calculations (e.g., for NVMe/TCP data digests and/or NVMe DIF/DIX data integrity); 9) thread local storage (TLS) processes; etc.

Notably, the packet processing pipeline ASIC block 723 and traffic shaper 724 correspond to the packet processing pipeline and load balancer described at length above with respect to FIGS. 1 through 4. As such, with at least one packet processing pipeline ASIC block 723 and at least one traffic shaper 724 ASIC block, one or more NICs can be integrated on a same IPU 707. In this case, the IPU's processing cores 711 correspond to the CPUs 101, 201, 301, 401 described at length above with respect to FIGS. 1 through 4 while the queues can be implemented within the IPU's local memory 729. The operating system and NIC device driver 210, 310, 410 described at length above with respect to FIGS. 2 through 4 can execute on one or more of the IPU's processing cores 711.

So constructed/configured, the IPU can be used to perform routing functions between endpoints within a same pool (e.g., between different host CPUs within CPU pool 601) and/or routing within the network 604. In the case of the later, the boundary between the network 604 and the IPU's pool can reside within the IPU, and/or, the IPU is deemed a gateway edge of the network 604.

The IPU 707 also includes multiple memory channel interfaces 728 to couple to external memory 729 that is used to store instructions for the general purpose cores 711 and input/output data for the IPU cores 711 and each of the ASIC blocks 721-726. The IPU includes multiple PCIe physical interfaces and an Ethernet Media Access Control block 730, and/or more direct channel interfaces (e.g., CXL and or AXI over PCIe) 731, to support communication to/from the IPU 707. The IPU 707 also includes a DMA ASIC block 732 to effect direct memory access transfers with, e.g., a memory pool 602, local memory of the host CPUs in a CPU pool 601, etc. As mentioned above, the IPU 707 can be a semiconductor chip, a plurality of semiconductor chips integrated within a same chip package, a plurality of semiconductor chips integrated in multiple chip packages integrated on a same module or card, etc.

Although embodiments above have perhaps emphasized that the CPUs 301, 401 that are fed packets by the NIC queues and perform some kind of routing function on the packets are implemented as processors that execute program code (the routing functions are implemented as software programs that are executed on the CPUs), in other embodiments the CPUs that perform the routing, and/or their routing functionality, can be implemented partially or wholly in ASIC form and/or partially or wholly in FPGA form. The term “CPU” can be used to refer to the circuitry used to implement any of these approaches (software, ASIC, FPGA or any combination thereof). A processor that executes program code can still be used to execute the aforementioned operating system and NIC device driver.

Embodiments of the invention may include various processes as set forth above. The processes may be embodied in program code (e.g., machine-executable instructions). The program code, when processed, causes a general-purpose or special-purpose processor to perform the program code's processes. Alternatively, these processes may be performed by specific/custom hardware components that contain hard wired interconnected logic circuitry (e.g., application specific integrated circuit (ASIC) logic circuitry) or programmable logic circuitry (e.g., field programmable gate array (FPGA) logic circuitry, programmable logic device (PLD) logic circuitry) for performing the processes, or by any combination of program code and logic circuitry.

Elements of the present invention may also be provided as a machine-readable storage medium for storing the program code. The machine-readable medium can include, but is not limited to, floppy diskettes, optical disks, CD-ROMs, and magneto-optical disks, FLASH memory, ROMs, RAMs, EPROMs, EEPROMs, magnetic or optical cards or other type of media/machine-readable medium suitable for storing electronic instructions.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
respectively adding respective identifiers of respective queues that provide packets to a CPU to a list in response to the respective queues being deemed quiet;
as a consequence of an interrupt having been generated in response to one of the respective queues having received a packet, removing the respective identifiers from the list and executing respective poll service handlers for the respective queues; and,
disabling those of the respective poll service handlers and adding those of the respective identifiers back to the list for those of the respective queues that are again deemed quiet, while, continuing executing others of the respective poll service handlers for others of the respective queues that are not deemed quiet.

2. The method of claim 1 further comprising registering respective poll objects for the respective queues through an application programming interface, wherein, the respective poll objects contain information used to invoke their respective queue's poll service handler.

3. The method of claim 2 wherein the application programming interface is an NDIS interface and the poll objects are NDIS_POLL_CHARACTERISTICS data structures.

4. The method of claim 2 further comprising binding the poll objects with the CPU.

5. The method of claim 1 wherein the respective poll service handlers refer to respective information that sets a limit on the amount of packet data that can be serviced from the respective queues.

6. The method of claim 4 wherein the interface is an NDIS interface and the information is contained within NDIS_POLL_RECEIVE_DATA data structures.

7. The method of claim 1 further comprising:
respectively adding second respective identifiers of second respective queues that provide packets to a second CPU to a second list in response to the second respective queues being deemed quiet;
as a consequence of a second interrupt having been generated in response to one of the second respective queues having received a packet, removing the second respective identifiers from the second list and executing second respective poll service handlers for the second respective queues; and,
disabling those of the second respective poll service handlers and adding those of the second respective identifiers back to the second list for those of the second respective queues that are again deemed quiet, while, continuing executing others of the second respective poll service handlers for others of the second respective queues that are not deemed quiet.

8. A machine readable storage medium containing program code that, when processed by one or more processors causes a method to be performed, the method comprising:
respectively adding respective identifiers of respective queues that provide packets to a CPU to a list in response to the respective queues being deemed quiet;
as a consequence of an interrupt having been generated in response to one of the respective queues having received a packet, removing the respective identifiers from the list and executing respective poll service handlers for the respective queues; and,
disabling those of the respective poll service handlers and adding those of the respective identifiers back to the list for those of the respective queues that are again deemed quiet, while, continuing executing others of the respective poll service handlers for others of the respective queues that are not deemed quiet.

9. The machine readable storage medium of claim 8 wherein the method further comprises registering respective poll objects for the respective queues through an application programming interface, wherein, the respective poll objects contain information used to invoke their respective queue's poll service handler.

10. The machine readable storage medium of claim 9 wherein the application programming interface is an NDIS interface and the poll objects are NDIS_POLL_CHARACTERISTICS data structures.

11. The machine readable storage medium of claim 9 wherein the method further comprises binding the poll objects with the CPU.

12. The machine readable storage medium of claim 8 wherein the respective poll service handlers refer to respective information that sets a limit on the amount of packet data that can be serviced from the respective queues.

13. The machine readable storage medium of claim 12 wherein the information is contained within NDIS_POLL_RECEIVE_DATA data structures of an NDIS interface.

14. The machine readable storage medium of claim 8 wherein the method further comprises:
respectively adding second respective identifiers of second respective queues that provide packets to a second CPU to a second list in response to the second respective queues being deemed quiet;
as a consequence of a second interrupt having been generated in response to one of the second respective queues having received a packet, removing the second respective identifiers from the second list and executing second respective poll service handlers for the second respective queues; and,
disabling those of the second respective poll service handlers and adding those of the second respective identifiers back to the second list for those of the second respective queues that are again deemed quiet, while, continuing executing others of the second respective poll service handlers for others of the second respective queues that are not deemed quiet.

15. A data center, comprising:
a network;
a memory pool coupled to the network;
a storage pool coupled to the network;
a host processor pool coupled to the network, the host processor pool comprising a processing unit coupled to local memory, the processing unit comprising a plurality of central processing units (CPUs), one or more packet processing pipeline and one or more traffic shaper circuits, wherein, packets that are processed by the one or more packet processing pipelines and the one or more traffic shaper circuits are placed into respective queues that are implemented within the local memory, wherein, the respective queues provide packets to one of the CPUs; and,
a machine readable storage medium containing program code that when processed by the processing unit causes a method to be performed, comprising:
respectively adding respective identifiers of the respective queues to a list in response to the respective queues being deemed quiet;
as a consequence of an interrupt having been generated in response to one of the respective queues having received a packet, removing the respective identifiers from the list and executing respective poll service handlers for the respective queues; and,
disabling those of the respective poll service handlers and adding those of the respective identifiers back to the list for those of the respective queues that are again deemed quiet, while, continuing executing others of the respective poll service handlers for others of the respective queues that are not deemed quiet.

16. The data center of claim 15 wherein the method further comprises registering respective poll objects for the respective queues through an application programming interface, wherein, the respective poll objects contain information used to invoke their respective queue's poll service handler.

17. The data center of claim 16 wherein the application programming interface is an NDIS interface and the poll objects are NDIS_POLL_CHARACTERISTICS data structures.

18. The data center of claim 16 wherein the method further comprises binding the poll objects with the CPU.

19. The data center of claim 15 wherein the respective poll service handlers refer to respective information that sets a limit on the amount of packet data that can be serviced from the respective queues.

20. The data center of claim 19 wherein the information is contained within NDIS_POLL_RECEIVE_DATA data structures of an NDIS interface.
